(19) United States
(12) Patent Application Publication
(10) Pub. No.: US 2021/0365900 A1
(43) Pub. Date: Nov. 25, 2021

(54) SYSTEMS AND METHODS FOR REUSABLE PRODUCT OR PACKAGING LIFECYCLE TRACKING, MONITORING, OR MANAGING

(71) Applicant: JOHN M. FEDYSKI, PHOENIX, AZ (US)

(72) Inventor: JOHN M. FEDYSKI, PHOENIX, AZ (US)

(21) Appl. No.: 17/326,990

(22) Filed: May 21, 2021

Related U.S. Application Data
(60) Provisional application No. 63/028,310, filed on May 21, 2020.

(51) Int. Cl. G06Q 10/00; G06Q 10/08

(52) U.S. Cl. CPC G06Q 10/30; G06Q 10/0833

(57) ABSTRACT

A method of generating a re-use identifier may comprise receiving, by the processor, a first identifier of a package; comparing, by the processor, the first identifier of the package to a first plurality of identifiers, each identifier in the plurality of first identifiers corresponding to a respective reuse package; determining, by the processor, whether the first identifier matches a matching identifier in the plurality of identifiers; and generating, by the processor, a label having a second identifier in response to the first identifier matching the matching identifier

### CROSS-REFERENCE TO RELATED APPLICATIONS

This application claims priority to and the benefit of U.S. Provisional Application No. 63/028,310 entitled “SYSTEMS AND METHODS FOR REUSABLE PRODUCT AND/OR PACKAGING LIFECYCLE TRACKING, MONITORING, AND/OR MANAGING,” filed on May 21, 2020. The disclosure of the foregoing application is incorporated herein by reference in its entirety, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to systems and method for analyzing product and/or packaging lifecycles, and in particular to tracking, monitoring and/or managing product and/or packaging lifecycles.

### BACKGROUND

In today's world, when someone drops a recyclable product and/or packaging in a recycle bin, they assume that the product and/or packaging will be properly recycled and that a portion of the material will be used to create a new product and/or packaging. This is not always the case as more and more items intended for recycling are now turning into garbage. Recycling is no longer the best option as it wastes resources, it's expensive, and there is a better way. We must replace recycling with reuse. Proper reuse of products and/or packaging saves natural resources, energy and money. Accordingly, product/packaging lifecycle tracking, monitoring and management systems and methods remain desirable to facilitate reuse systems by manufacturers and consumers alike.

### SUMMARY

A system for packaging lifecycle tracking is disclosed herein. The system may comprise: a processor; and a tangible, non-transitory memory configured to communicate with the processor, the tangible, non-transitory memory having instructions stored thereon that, in response to execution by the processor, cause the processor to perform operations comprising: receiving, by the processor, a first identifier of a package; comparing, by the processor, the first identifier of the package to a first plurality of identifiers, each identifier in the plurality of first identifiers corresponding to a respective reuse package; determining, by the processor, whether the first identifier matches a matching identifier in the plurality of identifiers; and generating, by the processor, a label having a second identifier in response to the first identifier matching the matching identifier.

In various embodiments, the operations further comprise sending, by the processor, the label to a user device. The operations may further comprise sending, by the processor, the second identifier to a product tracking database. The system may further comprise a plurality of drop-off apparatuses disposed in various locations. Each drop-off apparatus in the plurality of drop-off apparatuses may comprise a scanner, wherein the first identifier is received through the scanner. Each drop-off apparatus in the plurality of drop-off apparatuses may comprise a printing device, wherein the operations further comprise sending, by the processor, the label with the second identifier to the printing device. The operations may further comprise: sending the second identifier to a product tracking database; and compiling a plurality of second identifiers in the product tracking database, each identifier in the plurality of second identifiers corresponding to a distinct reuse package to be tracked. The operations may further comprise tracking a number of scans for each identifier in the plurality of second identifiers. The operations may further comprise calculating, by the processor, a carbon footprint impact based on the number of scans. The operations may further comprise generating a report including the carbon footprint impact.

A method of compiling, tracking, and monitoring reuse of a product is disclosed herein. The method may comprise: compiling, by a processor, packaging information for a plurality of package types, each package type in the plurality of package types comprising a plurality of potential re-use packages, the packaging information including a first identifier for each potential re-use package; receiving, by the processor and through a scanner, the first identifier for a first potential re-use package; and generating, by the processor, a label with a second identifier in response to receiving the first identifier, the second identifier including a unique identifier distinct to the first potential re-use package.

In various embodiments, the method may further comprise, querying, by the processor, users for the packaging information for the plurality of package types. The method may further comprise compiling, by the processor, a plurality of drop-off locations, wherein each drop-off location is configured to receive the first potential re-use package. The method may further comprise: receiving, by the processor and through a second scanner, the first identifier; and sending, by the processor, the packaging information associated with the plurality of potential re-use packages to a packaging tracking database; and sending, by the processor, tracking information to the packaging tracking database. The tracking information may comprise a timestamp. The method may further comprise querying, by the processor, a user for an additional packaging information in response to receiving the first identifier through the second scanner.

A system for packaging lifecycle management is disclosed herein. The system may comprise: a processor; and a tangible, non-transitory memory configured to communicate with the processor, the tangible, non-transitory memory having instructions stored thereon that, in response to execution by the processor, cause the processor to perform operations comprising: compiling, by the processor, packaging information for a plurality of package types, each package type in the plurality of package types comprising a plurality of potential re-use packages, the packaging information including a first identifier for each potential re-use package; compiling, by the processor, a plurality of drop-off locations, each drop-off location corresponding to a respective user in a plurality of users, each drop-off location configured to receive the plurality of potential re-use packages.

In various embodiments, the system further comprises a plurality of drop-off apparatuses, each drop-off apparatus corresponding to a respective drop-off location in the plurality of drop-off locations. The operations may further comprise compiling a plurality of re-use identifiers in response to the first identifier for the plurality of package types being scanned. The operations may further comprise tracking a number of scans for each re-use identifier in the plurality of re-use identifiers.

### BRIEF DESCRIPTION OF THE DRAWINGS

With reference to the following description and accompanying drawings:

FIG. 1 illustrates a product and/or packaging lifecycle management system, in accordance with various embodiments;

FIG. 2 illustrates a database for a product and/or packaging lifecycle management system, in accordance with various embodiments;

FIG. 3 illustrates a process for registering a product and/or packaging for tracking and/or managing, in accordance with various embodiments;

FIG. 4 illustrates a process for tracking and/or managing a reuse product and/or packaging, in accordance with various embodiments;

FIG. 5 illustrates an exemplary homepage of a mobile application comprising part of a product and/or packaging lifecycle management system in accordance with various embodiments;

FIG. 6 illustrates process flows in an exemplary mobile application in accordance with various embodiments;

FIG. 7 illustrates reporting functions in an exemplary mobile application in accordance with various embodiments; and

FIG. 8 illustrates feedback capabilities in an exemplary mobile application in accordance with various embodiments.

### DETAILED DESCRIPTION

The detailed description of various embodiments herein make reference to the accompanying drawings and pictures, which show various embodiments by way of illustration. While these various embodiments are described in sufficient detail to enable those skilled in the art to practice the disclosure, it should be understood that other embodiments may be realized, and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used herein, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

Principles of the present disclosure contemplate the use of a product and/or packaging lifecycle management system configured for use by consumers and companies. The product and/or packaging lifecycle management system may be configured to help consumers and companies move away from recycling and into a more environmentally friendly process of reuse. In particular, as described herein, “reuse” refers to a continual process throughout the lifecycle of a product and/or packaging, as opposed to a one-time use of a product and/or packaging before disposal or traditional recycling. The system disclosed herein greatly enhances transparency of environmental efforts, as well as allowing a user to monitor his or her impact on the environment. For example, by utilizing the systems and methods disclosed herein, a consumer may be able to look up and compare companies based on their impact on the environment (i.e., a consumer may determine which companies are using reusable products/packaging). In various embodiments, the systems and methods disclosed herein facilitates reuse of products by consumers and companies alike. Furthermore, the systems and methods disclosed herein provide an educational system for a consumer to know how and where a user may reuse products. In various embodiments, the systems and methods disclosed herein may facilitate tracking and/or calculating an environmental impact by city based on an amount of re-use within the city.

In various embodiments, the systems and methods disclosed herein make it easier for consumers to impact the environment. For example, the systems and methods disclosed herein allow a consumer to scan a product or package, learn whether the product is re-usable, learn where the consumer may drop off the product to be reused, and/or track any further reuse of the product. Thus, by providing a user with the knowledge of which products/packaging is re-usable, and allowing a user to track reuse of the product or packaging through various product/packaging lifecycles, a consumer may more easily and more readily impact the environment and view how specifically the consumer is making an impact.

The product and/or packaging lifecycle management system may comprise a consumer user interface (UI) and/or a second UI (e.g., a company UI). The consumer UI may allow a consumer to monitor and/or track the lifecycle of a product and/or packaging, learn about reusable products and/or packaging, track positive environmental aspects of reuse, find drop-off locations for reusable products and/or packaging, receive alerts when products and/or packaging are no longer suitable for reuse, provide feedback to companies about packaging materials, send recommendations to companies, share stories about reuse, and/or share information on how to protect personal information when participating in reuse processes. The second UI may allow a company to provide information on reusable products and/or packaging, track the lifecycle of a product and/or packaging, track the positive environmental aspects of reuse, provide drop-off locations for reusable products and/or packaging, notify consumers when a product and/or packaging is no longer suitable for reuse, solicit feedback about packaging materials, provide registration information for consumers to receive information about receiving products for reuse, facilitate environmental efforts, incentivize consumers to seek out reused products and/or packaging, recommend drop off locations for reused products and/or packaging, track data analytics, and/or provide information for consumers to protect personal information.

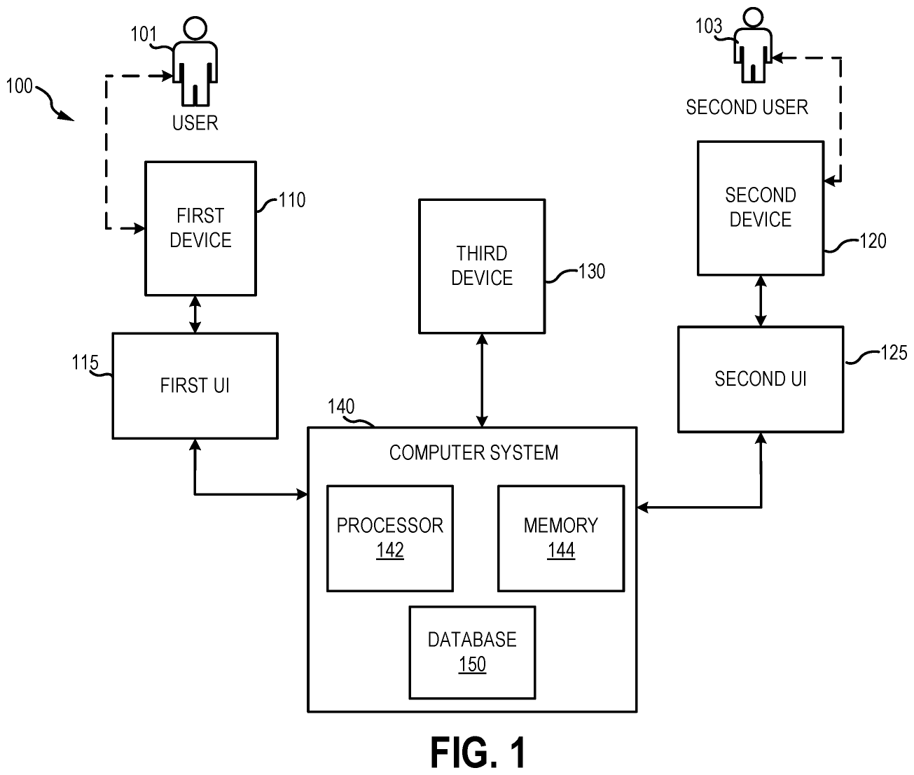

In various embodiments, and with reference to FIG. 1, a system 100 for product and/or packaging lifecycle tracking, monitoring, and/or managing is disclosed. In various embodiments, the system 100 includes a computer system 140 comprising a processor 142 and a memory 144. Computer system 140 is in communication with a first UI 115 and/or a second UI 125, which includes a first device 110, and a second device 120. Computer system 140 is further in communication with multiple external devices in accordance with the first device 110 and the second device 120, as well as a database 150. System 100 may be configured for tracking, monitoring, and/or managing products and/or packaging for reuse and may be one of a plurality of such systems operating together, or separately, to locate products and/or packaging, and/or provide information on the products and/or packaging to the appropriate parties. Such stations may share any of the devices or resources shown in FIG. 1.

In various embodiments, and as shown in FIG. 1, computer system 140 may store a software program configured to perform the methods described herein in the memory 144 and run the software program using the processor 142. The computer system 140 may include any number of individual processors 142 and memories 144. Various data may be communicated between the computer system 140 and a user via the first UI 115, and/or the second UI 125. Such information may also be communicated between the computer system 140 and the external devices (e.g., first device 110, and/or second device 120), database 150, and/or any other computing device connected to the computer system 140 (e.g., through any network such as a local area network (LAN), or wide area network (WAN) such as the Internet).

In various embodiments, system 100 depicted in FIG. 1, the processor 142 retrieves and executes instructions stored in the memory 144 to control the operation of the computer system 140. Any number and type of processor(s) (e.g., an integrated circuit microprocessor, microcontroller, and/or digital signal processor (DSP)), can be used in conjunction with the various embodiments. The processor 142 may include, and/or operate in conjunction with, any other suitable components and features, such as comparators, analog-to-digital converters (ADCs), and/or digital-to-analog converters (DACs). Functionality of various embodiments may also be implemented through various hardware components storing machine-readable instructions, such as application-specific integrated circuits (ASICs), field-programmable gate arrays (FPGAs) and/or complex programmable logic devices (CPLDs).

The memory 144 may include a non-transitory computer-readable medium (such as on a CD-ROM, DVD-ROM, hard drive or FLASH memory) storing computer-readable instructions stored thereon that can be executed by the processor 142 to perform the methods of the present disclosure. The memory 144 may include any combination of different memory storage devices, such as hard drives, random access memory (RAM), read only memory (ROM), FLASH memory, or any other type of volatile and/or nonvolatile memory.

The computer system 140 may receive and display information (such as information related to specific products and/or packaging) via the first UI 115 and/or the second UI 125. The user interfaces (e.g., the first UI 115 and/or the second UI 125) may include various peripheral output devices (such as monitors and printers), as well as any suitable input or control devices (such as a mouse and keyboard) to allow users to control and interact with the software program.

In various embodiments, first device 110 and second device 120 may each be in electronic communication with computer system 140, directly or via a respective user interface (e.g., first UI 115 and/or second UI 125). First device 110 and second device 120 may comprise any suitable hardware, software, and/or database components capable of sending, receiving, and storing data. For example, first device 110 and/or second device 120 may comprise a personal computer, personal digital assistant, cellular phone, smartphone (e.g., IPHONE®, BLACKBERRY® , and/or the like), IoT device, kiosk, and/or the like. First device 110 and/or second device 120 may comprise an operating system, such as, for example, a WINDOWS® mobile operating system, an ANDROID® operating system, APPLE® IOS®, a BLACKBERRY® operating system, a LINUX® operating system, and the like. First device 110 and/or second device 120 may also comprise software components installed on first device 110 and/or second device 120 and configured to enable access to various system 100 components. For example, first device 110 and/or second device 120 may comprise a web browser (e.g., MICROSOFT INTERNET EXPLORER®, GOOGLE CHROME® , etc.), an application, a micro-app or mobile application, or the like, configured to allow the first device 110 and/or the second device 120 to access and interact with computer system 140 (e.g., directly or via a respective UI, as discussed further herein).

In various embodiments, first device 110 may be configured to communicate with and/or interact with computer system 140 via first UI 115. First UI 115 may comprise a graphical user interface (GUI) accessible via a mobile application, web browser, software application, or the like. For example, first device 110 may interact with first UI 115 to instruct computer system 140 to provide information on reusable products and/or packaging by respective companies, track a lifecycle of a product and/or packaging, track environmental aspects of reuse, provide drop-off location for reusable products and/or packaging, receive alerts when a product and/or packaging is no longer suitable for reuse, provide feedback about reusable products and/or packaging provided by companies, send recommendations to companies, share stories about reuse of a reusable product, and/or provide first user with information on how to protect privacy during reuse. First device 110 may also interact with first UI 115 to track and/or monitor a product and/or packaging lifecycle. For example, first UI 115 may display one or more product and/or packaging lifecycles for a specific product and/or packaging a first user drops-off for reuse at a respective drop-off center through a second user 103. The product and/or packaging lifecycles may display various locations where a product and/or packaging has been, a number of times the product and/or packaging has been reused, various forms the product and/or packaging has taken, and/or the like. The product and/or packaging lifecycles may be generated and customized as desired, such as, for example, sorted by product, sorted by number of times reused, and/or the like. In various embodiments, a first user may be able to track a reuse product and/or packaging that the first user has used by inputting an identifier (either manually or via scanning an identifier of a reuse product).

In various embodiments, second device 120 may be configured to communicate with and/or interact with computer system 140 via the second UI 125. Second UI 125 may comprise a graphical user interface (GUI) accessible via a mobile application, web browser, software application, or the like. For example, second device 120 may interact with the second UI 125 to instruct computer system 140 to input information on reusable products and/or packaging, track a lifecycle of a product and/or packaging, track environmental aspects of reuse, input drop-off locations for reusable products and/or packaging that is offered, input information when a product and/or packaging is no longer suitable for reuse, link to a registration site for consumers to indicate willingness to receive products and/or packaging in a reused or recycled container, input material related to environmental efforts, input incentives offered for utilizing reused products and/or packaging, and/or track data analytics related to reusable products and/or packaging offered of first users 101. Second device 120 may also interact with second UI 125 to track and/or monitor a product and/or packaging lifecycle. For example, second UI 125 may display one or more product and/or packaging lifecycles for a specific product and/or packaging a first user drops-off for reuse at a respective drop-off center. Although described herein with respect to drop-off centers, drop-off locations and drop-off apparatuses, the present disclosure is not limited in this regard. For example, the computer system 140 may be configured to facilitate pick up of re-use products at a user's (e.g., first user 101) place of residence, in accordance with various embodiments. The product and/or packaging lifecycles may display various locations where a product and/or packaging has been, a number of times the product and/or packaging has been reused, various forms the product and/or packaging has taken, and/or the like. The product and/or packaging lifecycles may be generated and customized as desired, such as, for example, sorted by product, sorted by number of times reused, and/or the like.

In accordance with various embodiments, computer system 140 can track and trace reuse products and/or packaging in a product and/or packaging lifecycle via an electronic product code (EPC). The EPC can be any code, symbol, picture and/or any other unique identifier assigned to each item or subset of items in the chain. EPCs and other information regarding a reuse product and/or packaging may be stored in a barcode, QR code, radio frequency identification (RFID) tag or any other method or system for identifying an item (hereinafter a “product and/or packaging identifier”). The EPC may be attached to the reusable packaging, and/or associated with a product and/or packaging in any other desired manner. Accordingly, various embodiments may operate in conjunction with a third device 130 that includes a handheld scanner (e.g., a barcode scanner and/or RFID reader) for reading such information and communicating it to the computer system 140, database 150, or other system. Such scanners may communicate with the computer system 140 or other device through a wired connection, such as a universal serial bus (USB) connection, a computer network connection, a mobile device synchronization port connection, a power connection, a security cable and/or any other means set forth herein or known in the art. Such scanners may also communicate with any device operating in conjunction with the system through any desired wireless connection or network, such as a wireless Internet connection, a cellular telephone network connection, a wireless LAN connection, a wireless WAN connection, and/or an optical connection. Various embodiments may include, or operate in conjunction with, any other type of scanner or similar device.

The database 150 stores and/or compiles information related to products and/or packaging, as well as any other desired information (as further discussed herein). The database 150 may be implemented on computer system 140 or hosted by another system or device (such as a server) in communication with the system 100 via, for example, a network such as a LAN or WAN. In various embodiments, database 150 may be implemented as a relational database.

Any of the components in FIG. 1, as well as other systems and components operating with, or as part of, various embodiments may communicate with each other via a network (not shown). In various embodiments, one or more components of system 100 may include a wireless transceiver and the network may comprise a wireless system to allow wireless communication between various systems and devices, such as a wireless mobile telephony network, General Packet Radio Service (GPRS) network, wireless Local Area Network (WLAN), Global System for Mobile Communications (GSM) network, Personal Communication Service (PCS) network, Advanced Mobile Phone System (AMPS) network, and/or a satellite communication network. Such networks may be configured to facilitate communication via any other type of connection, such as a wired Internet connection, a wireless Internet connection, a cellular telephone network connection, a wireless LAN connection, a wireless WAN connection, an optical connection, a USB connection, and/or a mobile device synchronization port connection.

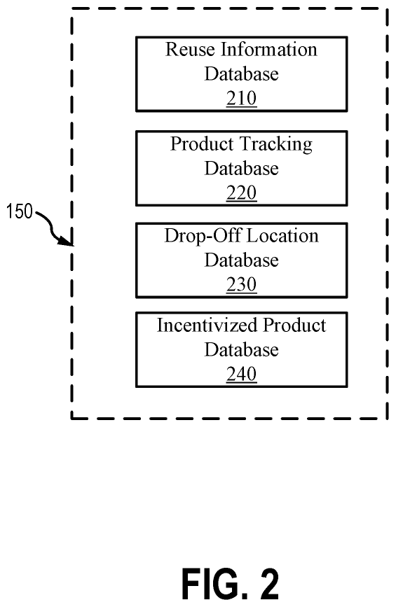

Referring now to FIG. 2, a database 150 of system 100 from FIG. 1 is illustrated, in accordance with various embodiments. The system 100 from FIG. 1 may comprise various databases within database 150. In various embodiments, the database 150 may comprise a reuse information database 210, a product and/or packaging tracking database 220, a drop-off location database 230, and/or an incentivized product and/or packaging database 240. The reuse information database 210 may store and/or compile information related to reusable products and/or packaging, environmental efforts, and/or information on how to remove labels from packaging without jeopardizing future reuse. The reuse information database may receive and/or compile information from a first device 110 and/or a second device 120 from FIG. 1, in accordance with various embodiments. The product and/or packaging tracking database 220 may store and/or compile information related to locations of products and/or packaging being tracked, types of use for products and/or packaging being tracked, number of times a product and/or packaging has been reused, and/or environmental benefits of re-using the products and/or packaging being tracked. The drop-off location database 230 may store and/or compile information related to locations of drop-off centers for reuse products and/or packaging for various companies of system 100 from FIG. 1. The incentivized product and/or packaging database 240 may store and/or compile information related to reuse products and/or packaging that companies have determined to add incentives to for users to use. In this regard, adding an incentivized reuse product and/or packaging to the incentivized product and/or packaging database 240 to provide customer rewards for using the incentivized product may result in wider adoption of reuse systems and methods. For example, customer rewards may comprise cash back, discounts, or the like. The various system components may communicate over a network.

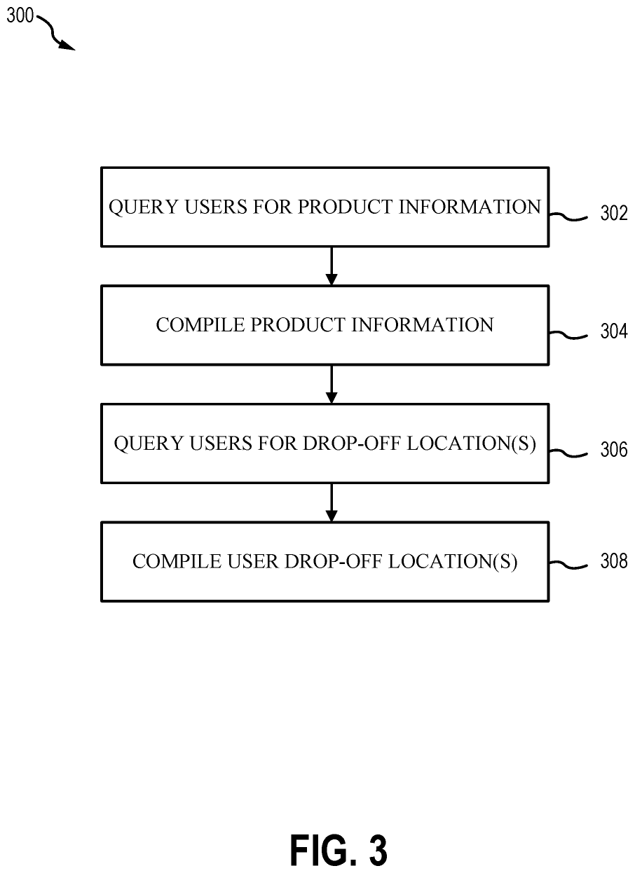

Referring to FIG. 3, a flowchart of a process 300 for compiling reuse product and/or packaging information with the system is illustrated according to various embodiments. In various embodiments, the process 300 comprises querying a plurality of users for product information (step 302). The users may be in accordance with second user 103 from FIG. 1. In various embodiments, the query may facilitate receiving product and/or packaging information that includes the product and/or packaging identifier, a product and/or packaging material, sustainability information of the product and/or packaging, size, types of products and/or packaging the reuse product and/or packaging holds, etc. The present disclosure is not limited in this regard. For example, various additional product and/or packing information may be facilitated from the plurality of users, in accordance with various embodiments.

In various embodiments, the process 300 further comprises compiling, within the reuse information database 210 from FIG. 2, the product and/or packaging information. In various embodiments, the product and/or packaging information may be compiled from querying the product information from step 302 or from a user inputting the product and/or packaging information on the user's own accord (e.g., via the second UI 125 through the second device 120 from FIG. 1). In this regard, a plurality of users (e.g., second user 103 from FIG. 1) may manually input product and/or packaging information to indicate their products and/or packaging is available for reuse and facilitate future reuse applications of their products and/or packaging.

In various embodiments, the process 300 further comprises querying the plurality of users for drop-off location(s) (step 306). In various embodiments, the drop-off location(s) may be associated with the specific user. For example, each user in the plurality of users from step 302 (e.g., the second user from FIG. 1) may own and/or operate their own drop-off location(s) for all of their products and/or packaging. In various embodiments, the query for drop-off location(s) of step 306 may include offer a respective user communal drop-off location (i.e., a network of drop-off locations facilitated by a third-party). In this regard, if a user in the plurality of users does not have drop off locations associated with the respective company, the user can utilize the network of drop-off locations to facilitate reuse of their product and/or packaging. In various embodiments, the network of drop-off locations may already be stored in the memory 144 of a computer system 140 from FIG. 1. In various embodiments, querying the plurality of users for the drop off location(s) may further comprise allowing a user to set up their drop-off locations as a network of drop-off locations for third party use as described above. In this regard, step 306 may provide a user with an option to use their own drop off locations, a network of drop-off locations that are pre-stored, and/or use drop-off locations provided by a third party within the system (e.g., another user in the plurality of second users 103 from FIG. 1). The various drop-off locations may include addresses for the locations, drop-off instructions, or the like. The drop-off location information may be stored, and/or compiled, in the drop-off location database 230 from FIG. 2.

In various embodiments, the process 300 further comprises compiling user drop-off locations (step 308). In various embodiments, the user drop-off locations may be compiled from querying the user drop-off locations from step 302 or from a user inputting the drop-off locations on the user's own accord (e.g., via the second UI 125 through the second device 120 from FIG. 1). In this regard, a plurality of users (e.g., second user 103 from FIG. 1) may manually input drop-off locations for product and/or packaging associated with that user or a plurality of users.

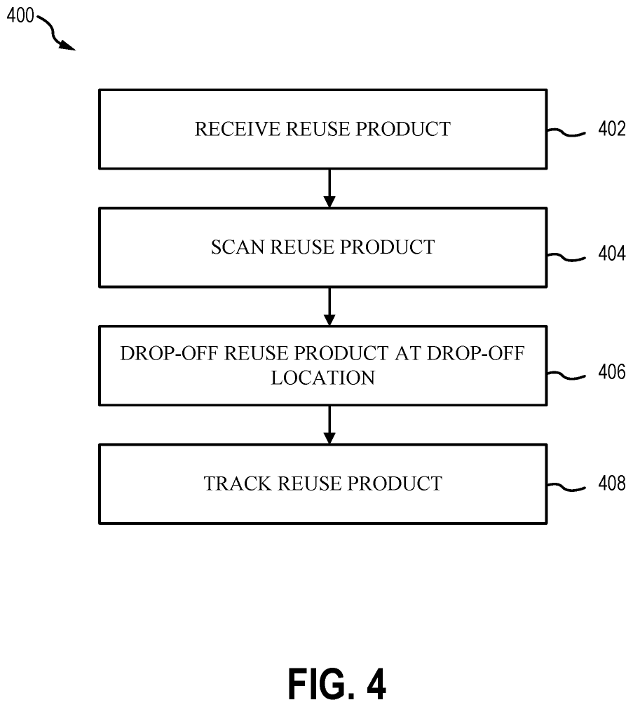

Referring now to FIG. 4, a flowchart of a process 400 for tracking and/or monitoring a reuse product and/or packaging with the system is illustrated according to various embodiments. A user of the system may receive a reuse product and/or packaging from a registered user (step 402). The user may manually enter or scan an identifier for the reuse product and/or packaging (step 404). In this regard, the reuse product and/or packaging may comprise a product and/or packaging identifier. After entering the identifier into the system, the user may add the reuse product and/or packaging to their tracker, or the product and/or packaging may be automatically added to a tracker for the user. The information may be stored, and/or compiled, in a product and/or packaging tracking database 220 from FIG. 2. Next, the user may drop-off the reuse product and/or packaging at a drop-off location for the registered user (step 406). After dropping off the product, the user may track the reuse product and/or packaging throughout various lifecycles of the reuse product and/or packaging (step 408). For example, upon receiving the reuse product and/or packaging from the drop-off location, a respective user may scan the identifier of the product and/or packaging any time the reuse product and/or packaging ends up in a new location. Upon scanning the identifier, a product and/or packaging lifecycle of the reuse product and/or packaging may be updated and viewable by the user. Additionally, when a second user scans the product and/or packaging after reuse, a location may be added to the tracker along with an indicator that the reuse product and/or packaging has been reused an additional time.

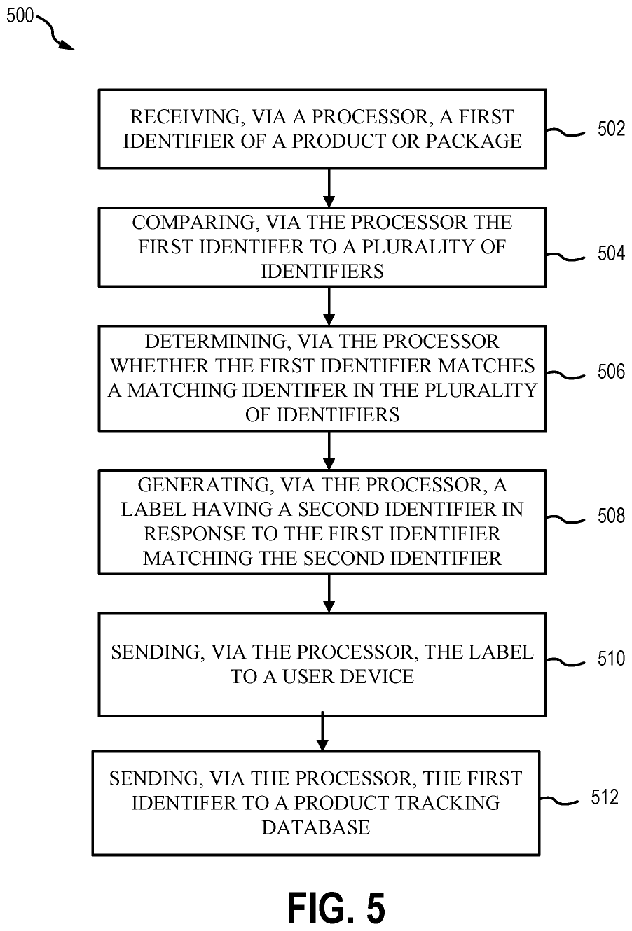

Referring now to FIG. 5, a method 500 of managing tracking of a reuse product and/or package is illustrated, in accordance with various embodiments. The method 500 comprises receiving, via a processor, a first identifier of a product and/or package (step 502). In various embodiments, the first identifier may be received in response to a user (e.g., first user from FIG. 1), scanning the first identifier via a user device (e.g., first device 110 from FIG. 1). The scanning method may be via a camera or the like.

The method 500 further comprises comparing, via the processor, the first identifier to a plurality of identifiers (step 504). The plurality of identifiers may be stored and/or compiled from process 300 within a reuse information database 210 from FIG. 2. The method further comprises determining, via the processor, whether the first identifier matches a matching identifier in the plurality of identifiers (step 506).

The method 500 further comprises generating, via the processor, a label having a second identifier in response to the first identifier matching the second identifier (step 508). The second identifier is associated with the product and/or package from step 502 until the product and/or package is discarded, recycled, or the like. In this regard, the second identifier may comprise a unique identifier specific to the product and/or package. In various embodiments, the method further comprises sending, via the processor, the label to a user device (step 510). The user device may be in accordance with the first device 110 from FIG. 1. In various embodiments, the label may then be printed by a respective user (e.g., first user 101) and affixed to the product and/or package. In this regard, upon being affixed to the product and/or package, the product and/or package may be monitored and tracked through various cycles of reuse. For example, a user (e.g., first user 101 from FIG. 1) may track the product and/or package through the user interface (e.g., first UI 115 from FIG. 1) as the product and/or package is reused multiple times and through the product and/or packages lifecycle.

In various embodiments, the method 500 further comprises sending, via the processor, the second identifier and reuse information to a product tracking database (e.g., packaging tracking database 220 from FIG. 2) (step 512). In various embodiments, the reuse information may include a timestamp of the scan, a location of the scan, any product and/or packing information from the first identifier, etc. In this regard, a first use may be logged within the product tracking database of the product and/or packaging, in accordance with various embodiments.

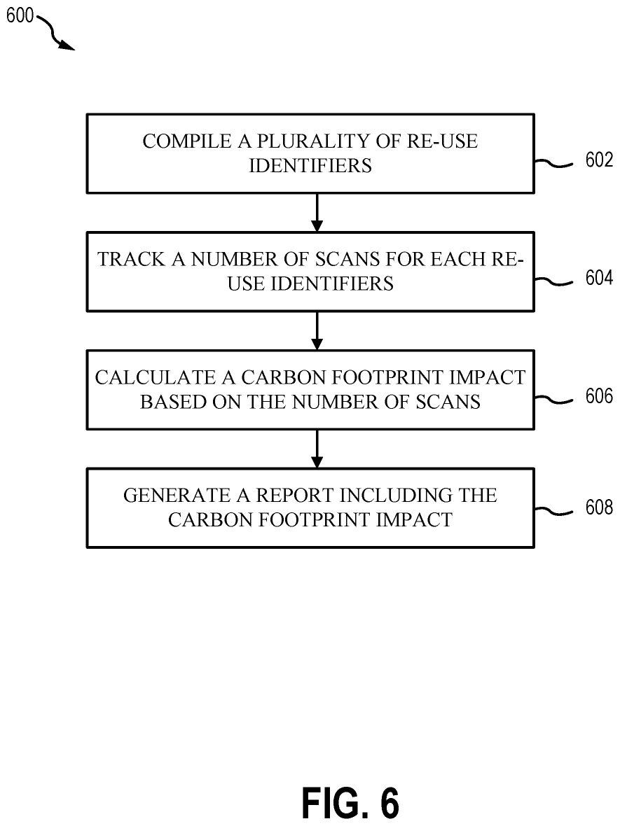

Referring now to FIG. 6 a method of determining a carbon footprint impact of re-using a product and/or packaging is illustrated, in accordance with various embodiments. In various embodiments, the method 600 comprises compiling a plurality of reuse identifiers (step 602). In various embodiments, each reuse identifier is a second identifier from the method 500 of FIG. 5. In this regard, each reuse identifier may be generated in response to a user (e.g., first user 101 from FIG. 1) scanning a first identifier of a product and/or packaging.

In various embodiments, the method 600 further comprises tracking a number of scans for each reuse identifier in the plurality of reuse identifiers (step 604). In this regard, a number of scans for each product and/or packaging that is reused as disclosed herein may be monitored. In various embodiments, the method 600 further comprises calculating a carbon footprint impact based on the number of scans (step 606). The carbon footprint impact may be calculated relative to a product not being used at all, relative to a product being recycled, or the like.

In various embodiments, the method 600 further comprises generating a report including the carbon footprint impact (step 608). In various embodiments, the report further comprises the number of scans for the respective product and/or packaging. In various embodiments, generating the report may further comprise compiling data from steps 604 and 606 for all products and/or packaging designated for reuse by a respective company (e.g., second user 103 from FIG. 1). For example, an amount of reuse of a respective company's products and/or packaging relative to their total products and/or packaging may further be calculated and generated (i.e., sent via computer system 140 to a display device such as second device 120 from FIG. 1).

In various embodiments, the method 600 further comprises tracking a number of scans for each reuse identifier in the plurality of reuse identifiers (step 604). In various embodiments, the tracking may comprise storing and/or compiling product and/or packaging data from each scan. For example, in response to a scan, the computer system 140 from FIG. 1 may query a user for additional information for the respective product and/or packaging, such as quality of the product and/or packing, etc.

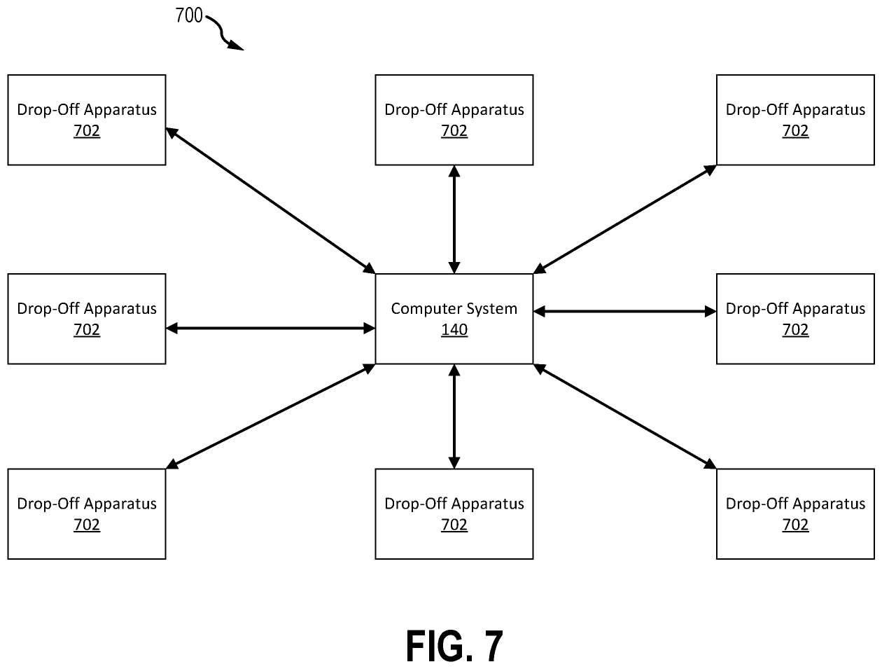

Referring now to FIG. 7, a schematic view of a reuse tracking and management system, system 700, is illustrated, in accordance with various embodiments. In various embodiments, the system 700 comprises a plurality of a drop-off apparatus 702. The drop-off apparatus may comprise a scanner and an inlet. In various embodiments, the scanner may be configured to read an identifier as described previously herein (e.g., a second identifier of the reuse product and/or packaging). In various embodiments the plurality of the drop-off apparatus may be disposed in various locations. For example, various locations may be across a given city, a region, a country, etc. In various embodiments, a user may be able to bring a reuse product and/or package as disclosed previously herein to the reuse apparatus, scan the second identifier of the label generated from method 500 and deposit the product and/or packaging into the drop-off apparatus.

In various embodiments, each drop-off apparatus may be in communication with the computer system 140 (e.g., via a network or the like). In this regard, the scanner of the drop-off apparatus 702 may be configured to transmit reuse data for a respective product and/or packaging through the network to computer system 140 and/or database 150 from FIG. 1, as described further herein.

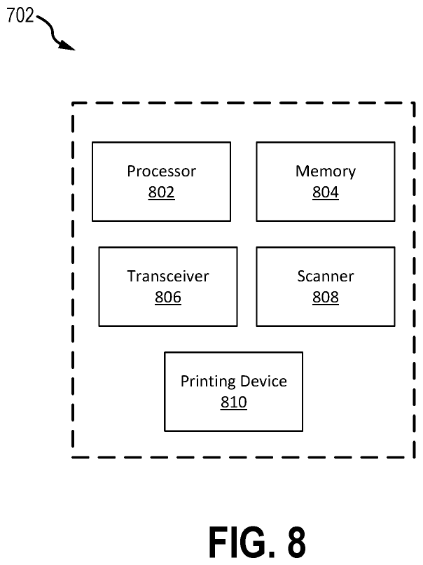

For example, referring now to FIG. 8, a schematic view of a drop-off apparatus 702 is illustrated, in accordance with various embodiments. The drop-off apparatus 702 comprises a processor 802, a memory 804, a transceiver 806, a scanner 808, and/or a printing device 810. In various embodiments, the drop-off apparatus may store a software program configured to perform the methods described herein in the memory 804 and run the software program using the processor 802. The drop-off apparatus 702 may include any number of individual processors 802 and memories 804. Various data may be communicated between the drop-off apparatus 702 and the computer system 140 from FIG. 1. Such information may also be communicated between the drop-off apparatus 702 and the external devices (e.g., first device 110, and/or second device 120 from FIG. 1), and/or any other computing device connected to the computer system 140 (e.g., through any network such as a local area network (LAN), or wide area network (WAN) such as the Internet).

In various embodiments, the drop-off apparatus 702 retrieves and executes instructions stored in the memory 804 to control the operation of the drop-off apparatus 702. Any number and type of processor(s) (e.g., an integrated circuit microprocessor, microcontroller, and/or digital signal processor (DSP)), can be used in conjunction with the various embodiments. The processor 802 may include, and/or operate in conjunction with, any other suitable components and features, such as comparators, analog-to-digital converters (ADCs), and/or digital-to-analog converters (DACs). Functionality of various embodiments may also be implemented through various hardware components storing machine-readable instructions, such as application-specific integrated circuits (ASICs), field-programmable gate arrays (FPGAs) and/or complex programmable logic devices (CPLDs).

The memory 804 may include a non-transitory computer-readable medium (such as on a CD-ROM, DVD-ROM, hard drive or FLASH memory) storing computer-readable instructions stored thereon that can be executed by the processor 802 which may perform the methods of the present disclosure. The memory 804 may include any combination of different memory storage devices, such as hard drives, random access memory (RAM), read only memory (ROM), FLASH memory, or any other type of volatile and/or nonvolatile memory.

In various embodiments, the transceiver 806, the scanner 808, and the printing device 810 are in operable communication with the processor 802. In various embodiments, the drop-off apparatus 702 may be operable in accordance with method 500 disclosed previously herein. For example, in response to receiving a scan of a first identifier, through the scanner 808, of a product or package in accordance with step 502 of method 500, the processor 802 may compare the first identifier to a plurality of identifiers in accordance with step 504, determine whether the first identifier matches a stored or compiled identifier in accordance with step 506, and generate a label having a second identifier when the first identifier matches a stored or compiled identifier. In various embodiments, the method may further comprise printing, via the printing device, the label with the second identifier as described previously herein. In this regard, instead of having a user print and attach their own labels generated through method 500, the drop-off apparatus may be configured to provide the label with the unique identifier (e.g., the second identifier) via the printing device 810 of the drop-off apparatus 702, in accordance with various embodiments. Thus, the drop-off apparatus 702 may provide a convenient and easy to use location to facilitate reuse of products and/or packaging.

In various embodiments, the transceiver 806 may be in communication with computer system 140 from FIG. 1, via a network or the like. Although described herein as comprising a transceiver, the present disclosure is not limited in this regard. For example, the transceiver 806 may be a transmitter, in accordance with various embodiments. In various embodiments, the transceiver 806 may be configured to transmit product and/or packaging data to the computer system 140 from FIG. 1. In this regard, the product and/or packaging data may include a timestamp, a location of the drop-off apparatus, latest information as to the quality of the product and/or packaging (i.e., which could have been input into the packaging tracking database 220 and/or the reuse information database 210 from FIG. 2), in accordance with various embodiments.

The various system components discussed herein may include one or more of the following: a host server or other computing systems including a processor for processing digital data; a memory coupled to the processor for storing digital data; an input digitizer coupled to the processor for inputting digital data; an application program stored, and/or compiled, in the memory and accessible by the processor for directing processing of digital data by the processor; a display device coupled to the processor and memory for displaying information derived from digital data processed by the processor; and a plurality of databases. Various databases used herein may include: client data; institution data; and/or like data useful in the operation of the system. As those skilled in the art will appreciate, user computer may include an operating system (e.g., WINDOWS®, UNIX®, LINUX®, SOLARIS®, MAC OS®, etc.) as well as various conventional support software and drivers typically associated with computers.

The present system, or any part(s) or function(s) thereof, may be implemented using hardware, software, or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by artificial intelligence (AI) or machine learning. Artificial intelligence may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

Further, illustrations of the process flows and the descriptions thereof may make reference to user WINDOWS® applications, webpages, websites, web forms, prompts, etc. Practitioners will appreciate that the illustrated steps described herein may comprise any number of configurations including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, components, modules, and/or engines of system 100 may be implemented as micro-applications, micro-apps, micro-services, or the like. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The systems, computers, computer-based systems, and the like disclosed herein may provide a suitable website or other Internet-based graphical user interface which is accessible by users. Practitioners will appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT and XML) programs, helper applications, plug-ins, and the like. A server may include a web service that receives a request from a web server, the request including a URL and an IP address. The web server retrieves the appropriate web pages and sends the data or applications for the web pages to the IP address. Web services are applications that are capable of interacting with other applications over a communication means, such as the Internet. Web services are typically based on standards or protocols such as XML, SOAP, AJAX, WSDL and UDDI. Web services methods are well known in the art, and are covered in many standard texts. As a further example, representational state transfer (REST), or RESTful, web services may provide one way of enabling interoperability between applications. In various embodiments, any communication discussed herein may be accomplished via the Internet or an Intranet. Communications may be completed using any suitable protocol, such as, for example, IPv4 (base 10), IPv6 (HMAC), and/or any other suitable or desired communications protocol.

In one embodiment, MICROSOFT company's Internet Information Services (IIS),

MTS service, and an SQL SERVER® database, are used in conjunction with MICROSOFT® operating systems, WINDOWS NT® web server software, SQL SERVER® database, and MICROSOFT® Servers. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

In various embodiments, the server may include application servers (e.g. WEBSPHERE®, WEBLOGIC JBOSS®, POSTGRES PLUS ADVANCED SERVER®, etc.). In various embodiments, the server may include web servers (e.g. Apache, IIS, GOOGLE® Web Server, SUN JAVA® System Web Server, JAVA® Virtual Machine running on LINTJX® or WINDOWS® operating systems). In various embodiments, service solutions may also include IaaS environments, PaaS environments, and/or the like.

Users, systems, computer-based systems or the like may communicate with the server via a web client. The web client includes any device or software which communicates via any network such as, for example any device or software discussed herein. The web client may include Internet browsing software installed within a computing unit or system to conduct communications. These computing units or systems may take the form of a computer or set of computers, although other types of computing units or systems may be used, including personal computers, laptops, notebooks, tablets, smart phones, cellular phones, personal digital assistants, servers, mainframe computers, distributed computing clusters, kiosks, terminals, televisions, or any other device capable of receiving data over a network. The web client may include an operating system (e.g., WINDOWS®, WINDOWS MOBILE® operating systems, UNIX® operating system, LINUX® operating systems, APPLE® OS® operating systems, etc.) as well as various conventional support software and drivers typically associated with computers. The web-client may also run MICROSOFT® INTERNET EXPLORER® software, MOZILLA® FIREFOX® software, GOOGLE® CHROME® software, APPLE® SAFARI® software, or any other of the myriad software packages available for browsing the Internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an Internet server. For example, the web client may communicate with the server via a load balancer. In various embodiments, web client access is through a network or the Internet through a commercially-available web-browser software package. In that regard, the web client may be in a home environment with access to the network or the Internet. The web client may implement security protocols such as Secure Sockets Layer (SSL) and Transport Layer Security (TLS). A web client may implement several application layer protocols including HTTP, HTTPS, FTP, and SFTP.

Any databases discussed herein may include relational, hierarchical, graphical, blockchain, object-oriented structure, and/or any other database configurations. In various embodiments, any database may also include a no-SQL database, a key-value database, an in-memory database, a GPU database, and/or the like. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual data and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like. Cryptography and network security methods are well known in the art, and are covered in many standard texts.

In various embodiments, the software elements of the system may also be implemented using a JAVASCRIPT® run-time environment configured to execute JAVASCRIPT® code outside of a web browser. For example, the software elements of the system may be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager such as, for example, Parallel Multithreaded Machine (“PM2”); a resource and performance monitoring tool such as, for example, Node Application Metrics (“appmetrics”); a library module for building user interfaces, and/or any other suitable and/or desired module.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an Internet-based embodiment, an entirely hardware embodiment, or an embodiment combining aspects of the Internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, SONY BLU-RAY DISC®, optical storage devices, magnetic storage devices, and/or the like.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

The present disclosure has been described with reference to various embodiments.

However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A system for packaging lifecycle tracking, comprising:
a processor; and
a tangible, non-transitory memory configured to communicate with the processor, the tangible, non-transitory memory having instructions stored thereon that, in response to execution by the processor, cause the processor to perform operations comprising:
receiving, by the processor, a first identifier of a package;
comparing, by the processor, the first identifier of the package to a first plurality of identifiers, each identifier in the plurality of first identifiers corresponding to a respective reuse package;
determining, by the processor, whether the first identifier matches a matching identifier in the plurality of identifiers; and
generating, by the processor, a label having a second identifier in response to the first identifier matching the matching identifier.

2. The system of claim 1, wherein the operations further comprise sending, by the processor, the label to a user device.

3. The system of claim 2, wherein the operations further comprise sending, by the processor, the second identifier to a product tracking database.

4. The system of claim 1, further comprising a plurality of drop-off apparatuses disposed in various locations.

5. The system of claim 4, wherein each drop-off apparatus in the plurality of drop-off apparatuses comprises a scanner, wherein the first identifier is received through the scanner.

6. The system of claim 5, wherein each drop-off apparatus in the plurality of drop-off apparatuses comprises a printing device, wherein the operations further comprise sending, by the processor, the label with he second identifier to the printing device.

7. The system of claim 1, wherein the operations further comprise:
sending the second identifier to a product tracking database; and
compiling a plurality of second identifiers in the product tracking database, each identifier in the plurality of second identifiers corresponding to a distinct reuse package to be tracked.

8. The system of claim 7, wherein the operations further comprise tracking a number of scans for each identifier in the plurality of second identifiers.

9. The system of claim 8, wherein the operations further comprise calculating, by the processor, a carbon footprint impact based on the number of scans.

10. The system of claim 9, wherein the operations further comprises generating a report including the carbon footprint impact.

11. A method of compiling, tracking, and monitoring reuse of a product, the method comprising:
compiling, by a processor, packaging information for a plurality of package types, each package type in the plurality of package types comprising a plurality of potential re-use packages, the packaging information including a first identifier for each potential re-use package;
receiving, by the processor and through a scanner, the first identifier for a first potential re-use package; and
generating, by the processor, a label with a second identifier in response to receiving the first identifier, the second identifier including a unique identifier distinct to the first potential re-use package.

12. The method of claim 11, further comprising, querying, by the processor, users for the packaging information for the plurality of package types.

13. The method of claim 11, further comprising compiling, by the processor, a plurality of drop-off locations, wherein each drop-off location is configured to receive the first potential re-use package.

14. The method of claim 11, further comprising:
receiving, by the processor and through a second scanner, the first identifier; and
sending, by the processor, the packaging information associated with the plurality of potential re-use packages to a packaging tracking database; and
sending, by the processor, tracking information to the packaging tracking database.

15. The method of claim 14, wherein the tracking information comprises a timestamp.

16. The method of claim 14, further comprising querying, by the processor, a user for an additional packaging information in response to receiving the first identifier through the second scanner.

17. A system for packaging lifecycle management, comprising:
a processor; and
a tangible, non-transitory memory configured to communicate with the processor, the tangible, non-transitory memory having instructions stored thereon that, in response to execution by the processor, cause the processor to perform operations comprising:
compiling, by the processor, packaging information for a plurality of package types, each package type in the plurality of package types comprising a plurality of potential re-use packages, the packaging information including a first identifier for each potential re-use package; and
compiling, by the processor, a plurality of drop-off locations, each drop-off location corresponding to a respective user in a plurality of users, each drop-off location configured to receive the plurality of potential re-use packages.

18. The system of claim 17, further comprising a plurality of drop-off apparatuses, each drop-off apparatus corresponding to a respective drop-off location in the plurality of drop-off locations.

19. The system of claim 17, wherein the operations further comprise compiling a plurality of re-use identifiers in response to the first identifier for the plurality of package types being scanned.

20. The system of claim 19, wherein the operations further comprise tracking a number of scans for each re-use identifier in the plurality of re-use identifiers.
